(19) United States
(12) Patent Application Publication
(10) Pub. No.: US 2013/0103284 A1
(43) Pub. Date: Apr. 25, 2013

(54) SYSTEM FOR MONITORING THE COOLANT LEVEL AND THE TEMPERATURE OF AN INTERNAL COMBUSTION ENGINE

(71) Applicant: Jaime Gordon, Netanya (IL)

(72) Inventor: Jaime Gordon, Netanya (IL)

(73) Assignee: EL-SOL TECHNOLOGIES LTD., Netanya (IL)

(21) Appl. No.: 13/806,014

(22) PCT Filed: Jun. 23, 2011
(86) PCT No.: PCT/IL11/00501

§ 371 Date: Dec. 20, 2012

Related U.S. Application Data
(60) Provisional application No. 61/358,914, filed on Jun. 27, 2010.

(51) Int. Cl. G06F 11/30

(52) U.S. Cl. CPC G06F 11/30
USPC 701/101

(57) ABSTRACT

The present invention relates to a non-invasive engine guard system, which comprises: a) at least one ultrasonic sensor for providing data representing the cooling fluid level in a coolant hose, wherein said coolant hose connects between said engine and a radiator; b) a temperature sensor for monitoring” whether the temperature of said engine or said coolant hose is not above a predetermined level; c) attaching means for externally attaching said ultrasonic sensor and said temperature sensor on top of said coolant hose; d) an electronic unit for controlling said system, processing said data, and for generating information related to the temperature and the cooling fluid level in said coolant hose.

### FIELD OF THE INVENTION

The present invention relates to the field of engine monitoring system. More particularly, the invention relates to an automatic audio-visual system for monitoring the temperature and whether there is a lack of coolant liquid (e.g., due to leaks) on internal combustion engines, which are cooled by a coolant liquid.

### BACKGROUND OF THE INVENTION

Vehicles such as automobiles and cars are one of the central assets belonging to the private person, families and organizations. This asset is of paramount importance in the family or organization annual money budget. This means that preventive maintenance must be periodically perform for keeping the automobile in good working condition, mechanical and safety, to be able to enjoy the good driving conditions and keep a good market price of the automobile asset in case that the owner would like to sell it. But in reality it is not always this way and unexpected occurrences and faults happen to the vehicle. Many vehicle faults are due to problems occurring in the engine. These faults in general can be tracked and monitored by the engine temperature.

All vehicle engines have a normal working temperature which is defined and determined by the manufacturer of the specific engine. Shifting out of this specific temperature range means that a fault in the engine or related parts has occurred or is developing. The keeping of engine's temperature in the normal working temperature range is managed by a “cooling system” of the vehicle's engine. Typical cooling system comprises a series of sensors, thermostats, cooling radiator, ventilator, cooling fluid, hoses, cooling system pump, feedback controls, electronics, indicators, etc. Of course a fault may also develop in the cooling system itself and affect the normal functioning of the engine, like improper cooling of the engine or not cooling at all.

Both of these engine faults can be catastrophic that could prevent proper functioning of the engine and even stop the engine from functioning at all. These type of faults must be detected promptly and on due time before they make a mayor or irreparable fault to the engine. These types of faults are in general quite expensive, and the repair can cost between few hundreds USD up to several thousands USD, and in some case the repair could cost much more. In some cases the engine cannot be repaired at all and an “engine exchange” must be performed which is more costly and the vehicle in general will not be back to its original operation as it was before this catastrophic failure.

Due to all the above mentioned reasons it is imperative to have in the automobile a good and reliable temperature and cooling fluid monitoring and alarm system that will make the user aware in due course if a fault is or has developed in the engine. In the prior art several attempts were made in order to provide systems that will alert the driver in case of such cooling failures, however such system (which usually exists in some models of new vehicles) are quite ambiguous and drivers not always clearly understand the real problem that such system is trying to convey. Moreover, in many vehicles (especially older models) such systems are quite precarious.

Although prior-art monitoring and alarm systems are proposed in the market, however none of them is a non-invasive system. All of the alarms proposed before are invasive, which means that their installations need to “go into” the engine parts in some way, e.g., by cutting a hose or some type of introduction of the sensors inside the engine or other components. Other systems required also to penetrate the data communication infrastructure of the vehicle such as the Controller Area Network (known as CAN or CAN-bus) of the vehicle.

It is an object of the present invention to provide an engine guard system which is capable of providing a clear and non ambiguous alert to the driver.

It is another object of the present invention to provide a non invasive implementation and easy of installation of an engine guard system.

Other objects and advantages of the invention will become apparent as the description proceeds.

### SUMMARY OF THE INVENTION

The present invention relates to an engine guard system, which comprises: a) at least one ultrasonic sensor for providing data representing the cooling fluid level in a coolant hose, wherein said coolant hose connects between said engine and a radiator; b) a temperature sensor for monitoring whether the temperature of said engine or said coolant hose is not above a predetermined level; c) attaching means for externally attaching said ultrasonic sensor and said temperature sensor on top of said coolant hose; d) an electronic unit for controlling said system, processing said data, and for generating information related to the temperature and the cooling fluid level in said coolant hose; e) communication means for communicating between said electronic unit and said ultrasonic and temperature sensors (either by wired or wireless communication lines); and f) a display, electronically connected to said electronic unit, for displaying said generated information and an audio alarm (buzzer) for providing an audible alert whenever the temperature in said hose is above a predetermined threshold level and/or the coolant level in said hose is below a predetermined threshold level.

According to an embodiment of the present invention, the attaching means can be a hose collar, a manufactured hose or any other form of built-in hose which includes the temperature sensor and the ultrasonic sensor.

According to some embodiment of the present invention, the electronic unit further comprises a calendar and a clock for documenting fault timing of the engine and/or the coolant system.

According to an embodiment of the present invention, the electronic unit further comprises: an additional data transfer means, a cellular communication module (e.g., GSM) and a GPS module for communicating engine faults to a remote subscriber. For example, the additional data transfer means can be a USB connection, a wireless connection (e.g., Bluetooth) or combination thereof.

### BRIEF DESCRIPTION OF THE DRAWINGS

In the drawings:

FIG. 1 schematically illustrates an engine guard system, according to an embodiment of the present invention;

FIG. 2 schematically illustrates the engine guard system provided with sensors installing means, according to an embodiment of the present invention;

FIG. 3 schematically illustrates the installation of the engine guard system in a vehicle, according to an embodiment of the present invention;

FIG. 4 schematically illustrates a vehicle provided with the engine guard system of the present invention; and

FIG. 5 schematically illustrates an ultrasonic sensor, according to an embodiment of the present invention.

### DETAILED DESCRIPTION OF PREFERRED EMBODIMENTS

The following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The present invention is an engine guard system which solves exactly this problem, it is an audio-visual engine monitor and alarm system that constantly (from the starting of the engine till the engine is shut off) checks whether the temperature of the engine is bellow the dangerous high temperature zone and whether there is no lack of cooling fluid (the coolant). It should be noted that the engine guard system also increases driving safety due to the fact that such a catastrophic failure may occur when driving say, e.g., on the highway and if suddenly the engine stops working, such a situation can be dangerous for the vehicle driver itself and all the other drivers around it. In the case an engine guard system is installed in a vehicle then this audio visual monitor and alarm system would make the driver alert and aware of the problem and driver should stop driving and park the vehicle safely.

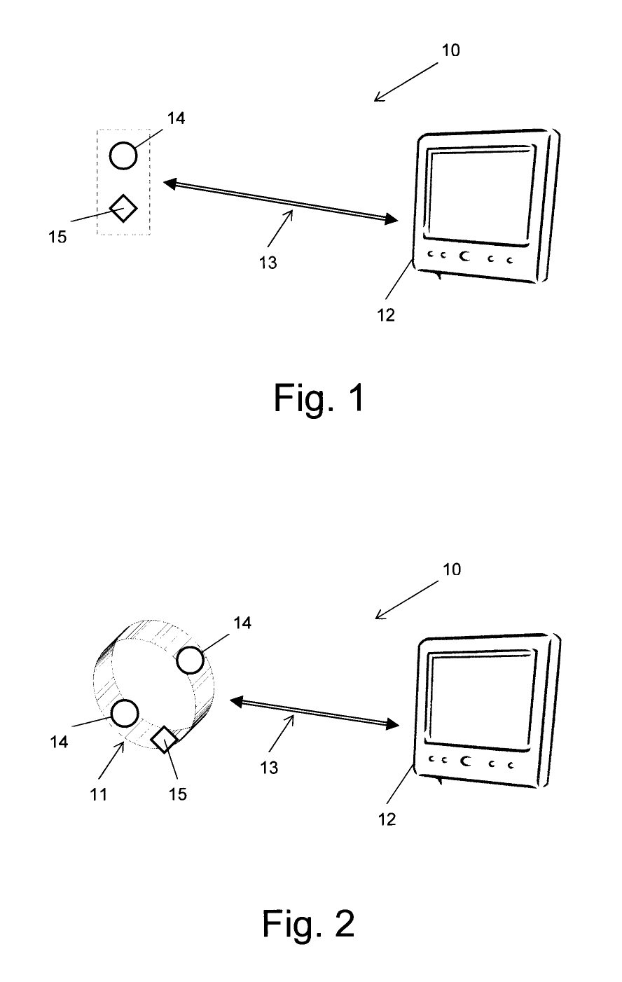

FIG. 1 schematically illustrates an engine guard system 10, according to an embodiment of the present invention. The engine guard system 10 comprises: at least one ultrasonic sensor 14, a temperature sensor 15 and an electronic unit 12. The ultra sonic sensors 14 and the temperature sensor 15 are located at the engine area of the vehicle and the electronic unit 12 is located in the drivers area (i.e., in the vehicle's passengers compartment).

According to an embodiment of the present invention, each ultrasonic sensor 14 constantly checks the level of the cooling fluid, while the temperature sensor 15 constantly checks the temperature of the vehicle's engine (i.e., in order to detect whenever the engine's temperature is increased above a predetermined threshold temperature level which is defined as the dangerous high temperature region).

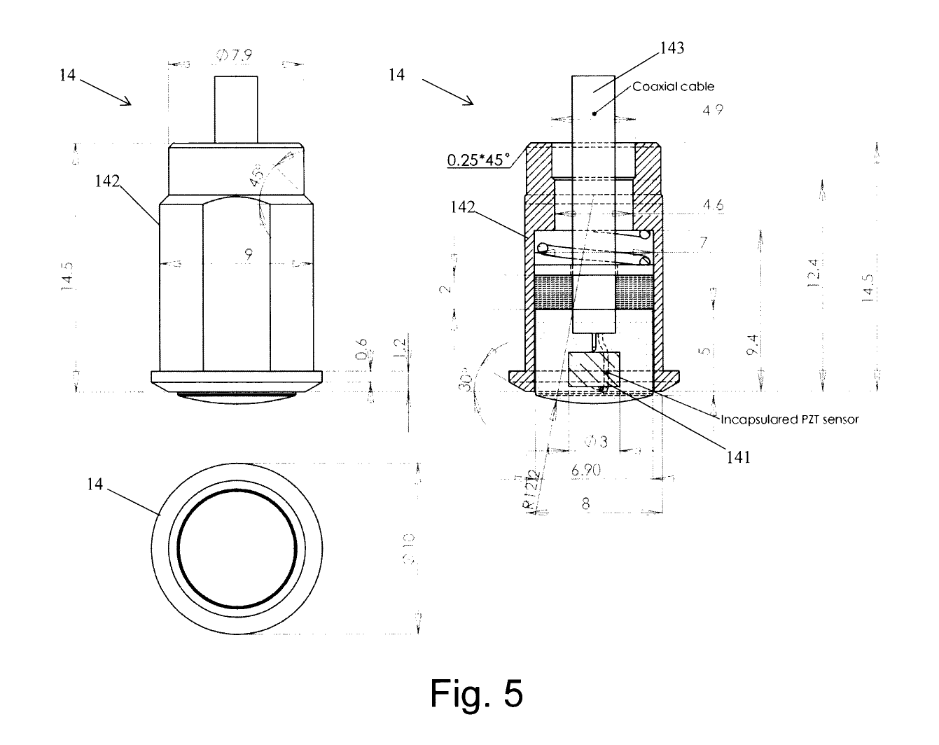

FIG. 5 schematically illustrates the ultrasonic sensor 14, according to an embodiment of the present invention. The ultrasonic sensor comprises a piezo transducer 141, a housing 142 and a coaxial cable 143.

The ultrasonic sensor/s (transmitter and receiver) may be implemented using two piezo transducers (PZT) in which one transmits the ultrasonic wave of the required amplitude and frequency for the media that should be transposed (the elastomeric hose end the coolant liquid which is inside the hose) and detect if there is an attenuation of the ultrasonic wave transmitted or if there is not attenuation at all of the transmitted ultrasonic wave. According to some embodiments of the present invention, a second implementation of the ultrasonic sensor can be done using only one ultrasonic piezoelectric transducer and using it in “both ways”, in alternating de electronic drivers as transmitter and afterwards as a receiver, in such embodiments the electronics and drivers are implemented in such a way that they switch in time the function alternating between transmitter and receiver.

The temperature sensor (i.e., the thermal protector sensor) can be any type of thermal sensor suitable to measure the engine temperature as well as resists the relatively the temperatures of the engine surroundings (e.g., the snap action thermostats Model 11 MP of Portage Electric Products, Inc).

According to some embodiments of the present invention, the ultrasonic sensors 14, the temperature sensor 15 and the electronic unit 12 are electrically connected using wired communication lines 13. Alternatively, the sensors 14 and 15 and the electronic unit 12 can be wirelessly connected using any suitable set of wireless protocols used for data transfer, such as Bluetooth, ZigBee, etc. The engine guard system 10 can be powered by the regular vehicle battery as any electronic vehicle accessory such as a car's radio or CD player. Optionally, the engine guard system 10 may further comprise a rechargeable battery or other type of internal power source (not shown) which, for example, can be installed within a housing which is designed and configured for covering and/or protecting the electronic unit 12.

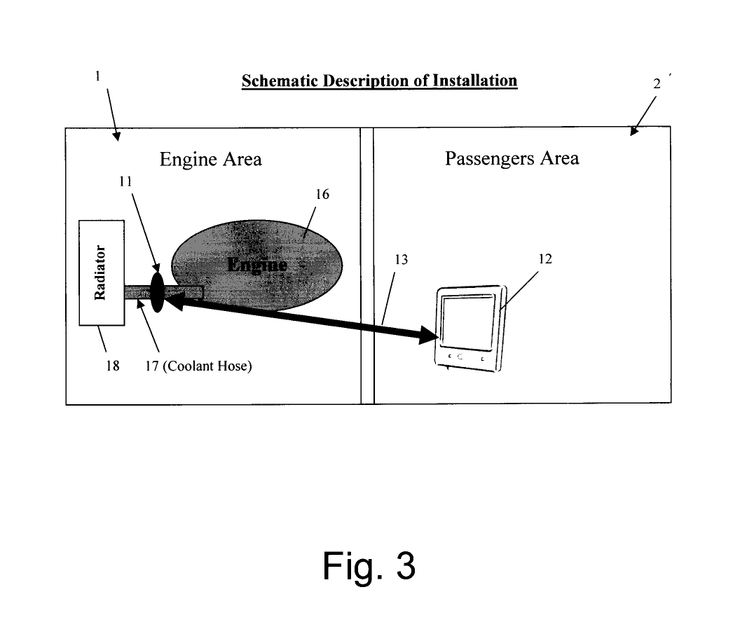

Referring now to FIGS. 2 and 3, the ultrasonic sensors 14 and the temperature 15 can be installed in the vehicle's engine area in a variety of ways. For example, according to an embodiment of the present invention, two ultrasonic sensors 14 and a single temperature sensor 15 are installed using a conventional hose collar 11 on one of the coolant hose (e.g., the hose that connects between the engine and the radiator as shown with respect to FIG. 3). The two ultrasonic sensors 14 and the temperature sensor 15 are installed on the collar 11 in such a way that the ultrasonic sensors 14 will be able to constantly check the cooling fluid level, and the temperature sensor 15 will be able to check that the temperature did not enters into the dangerous high temperature region. For example, the two ultrasonic sensors 14 can be positioned on the collar 11 while they are facing each other (i.e., in 180 degrees) as shown with respect to FIG. 2. For example, using two ultrasonic sensors PZTs makes the driving and controlling electronics less complicated and can be analogically implemented instead of using only one PZT ultrasonic sensor. Using only one ultrasonic PZT sensor may make the control electronics much complicated and probably implemented by digital electronics. However, there is no real difference between using a single or two ultrasonic sensors. Usually such sensors require an electronic driving circuit (i.e., a driver) for allowing their operation. Such electronic circuit can be installed with the collar hose 11 or alternatively embedded within the electronic unit 12.

The electronic unit 12 is installed in the passengers' compartment near by the driver. According to an embodiment of the present invention, the electronic unit 12 includes a display (e.g., LEDs or LCD screen), an audio alarm (e.g., buzzer), a control module (e.g., a controller or a microcontroller) and a communication module. For example, the display may consist of 3 LEDs, one green, one blue and one red, which functions as follows:
1. When the vehicle's engine is started the control module makes a “self test” and checks that the sensors 14 and 15 and the electronics of the electronic unit 12 are operative (i.e., whether they function properly), Green LED is lit and an “OK” sound (or buzzer signal) is played or generated.
2. If the engine's temperature or coolant levels are normal, the Green LED will remain light up as long as the vehicle's engine is working (usually during the all driving time) and the other LEDs, say Blue and Red will not lit.
3. But, in case a non normal operating temperature situation is monitored in the engine by the temperature sensor 15 and/or low level in the coolant fluid is detected by the ultrasonic sensor(s) 14, the control module will generate accordingly an alert signal which will cause to an alarm that will immediately sound (e.g., by the buzzer) and the Blue LED will lit (if the problem is with the coolant fluid) or the Red LED (if the problem is a high temperature) or both LEDs (Blue and Red) will lit in case that both problems exist, temperature and coolant level.

Referring now to FIG. 3, the engine guard system 10 of the present invention provides a uniqueness of non invasive monitor and audio visual alarm system. In this embodiment, the engine guard system 10 consists the following elements (see also FIG. 2):
a. The hose collar 11 (on which the temperature sensor 15 and the ultrasonic sensors 14 are installed) is located in the engine area 1 of a vehicle and is attached to the coolant hose 17 which connects between the radiator 18 and the engine 16 of the vehicle. The ultrasonic sensor(s) 14 constantly checks the level of the coolant. If coolant level becomes low than a predetermined level or the temperature sensor 15 detects that the temperature level becomes higher than its predetermined threshold level then an audio-visual alarm will generated in order to worn the driver.
b. Electronic unit 12 is installed in the passengers' compartment 2 of the vehicle and is constantly conveys the pertinent data from the sensors 14 and 15 to the driver. Optionally, electronic unit 12 may also have a calendar and a clock that will display date and time and also register time and date of alarm events. This unit may also have a communications interface like USB or Bluetooth, etc. in order to communicate with “the outside world” (e.g., with a computer station in a garage).
c. A communication interface (or link) 13 between the sensors 14 and 15 the electronic unit 12, that can be either wired or wireless, as known to a person skilled in the art.

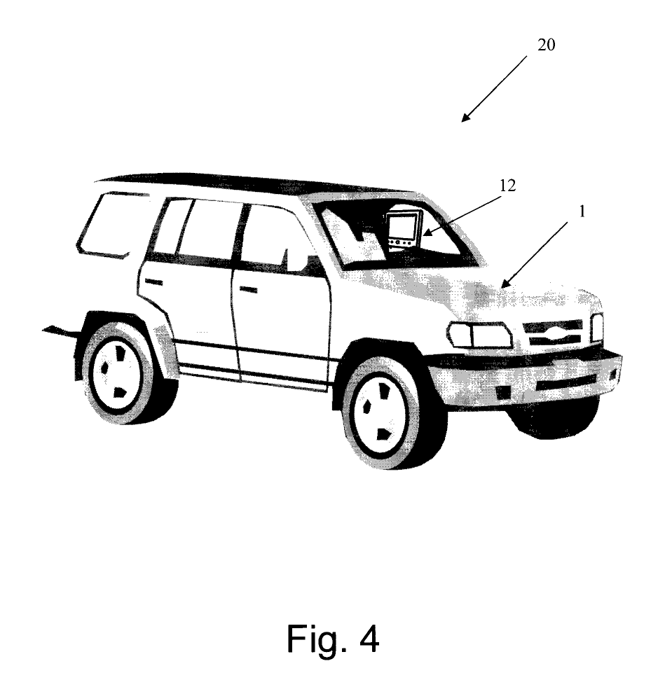

FIG. 4 schematically illustrates a vehicle 20 provided with the engine guard system of the present invention. In this figure, the electronic unit 12 is installed in the passengers' compartment of vehicle 20, and the sensors 14 and 15 (not shown) are installed in the engine area 1. It should be noted that the engine guard system 10 of the present invention can be designed for different vehicle models, trucks, boats, yachts, so they may have different sizes and some different features according to the different models.

The Operation of the Engine Guard System

a. The engine guard system of the present invention starts its operation when the vehicle's engine is started. First it makes a self test where it checks that the sensors are operative and the display LEDs and the buzzer are working correctly;

b. The engine guard checks constantly, the whole driving time (even when the vehicle is stopped or parked but its engine is still working), that the temperature and the coolant level of the vehicle's engine are in normal operating zone; and

c. When the engine is shuttled off the engine guard also turns off.

The engine guard system may perform the following function:

a. self test;

b. constant check of temperature and coolant level;

c. if there is an higher irregular temperature the systems warns the driver;

d. if there is a low level in the coolant then the system warns the driver;

e. if there is both, a temperature and a low level irregularity the system will make both types of warns to the driver; and

f. the alarms indication can be an audio signal, visual signal or combination thereof.

In some embodiments, the system of the present invention may further include one or more of the following elements or modules: a calendar, a clock, a USB connection, a Bluetooth connection, a cellular communication module (e.g., GSM) and/or a GPS connection for communicating engine faults to some “remote subscriber”, this functions will be able to inform the remote subscriber of the problem on a specific vehicle and/or its location.

According to an embodiment of the present invention, the system further comprises a “green” module (i.e., an environmental friendly sub-system). The “green” module checks whether the engine comes up to an optimal temperature within a given time period (e.g., to a predetermined temperature in about 30 minutes), and if not, this may indicate of a fault in the engine that makes it more pollutant to the environment (e.g., as it may produces much internal soot than the standard defined level). The “green” module can be implemented by software means (e.g., a dedicated program code), hardware means (e.g., a dedicated timer circuit), or any combination thereof that, for example, will all be implemented within the electronic unit 12.

The engine guard system described herein can monitor the temperature in the outside of the top cooling hose of the cooling system and on the same area it also monitors, with an ultrasonic sensor, the level of the coolant in the system. This non-invasive installation means that the engine guard system of the present invention is easy for installation, for example, it can be installed in less than half an hour by a vehicle electrician or a mechanic or it can also be installed quite simply by any person with “a good and fair hands and technical approach”. With this automatic audio-visual monitor and alarm system the driver can be most secure that faults of this type will be announced to him before a catastrophic event may occur.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. An engine guard system, comprising:
a) at least one ultrasonic sensor for providing data representing the cooling fluid level in a coolant hose, wherein said coolant hose connects between said engine and a radiator;
b) a temperature sensor for monitoring whether the temperature of said engine or said coolant hose is not above a predetermined level;
c) attaching means for externally attaching said ultrasonic sensor and said temperature sensor on top of said coolant hose;
d) an electronic unit for controlling said system, processing said data, and for generating information related to the temperature and the cooling fluid level in said coolant hose;
e) communication means for communicating between said electronic unit and said ultrasonic and temperature sensors; and
f) a display, electrically connected to said electronic unit, for displaying said generated information and an audio alarm (buzzer) for providing an audible alert whenever the temperature in said hose is above a predetermined threshold level and/or the coolant level in said hose is below a predetermined threshold level.

2. An engine guard system according to claim 1, in which the communication means are wired or wireless communication lines.

3. An engine guard system according to claim 1, in which the attaching means is a hose collar

4. An engine guard system according to claim 1, in which the attaching means is a manufactured hose or a built-in hose which includes the temperature sensor and the ultrasonic sensor.

5. An engine guard system according to claim 1, in which the electronic unit further comprising a calendar and a clock for documenting fault timing of the engine and/or the coolant system.

6. An engine guard system according to claim 1, in which the electronic unit further comprising: an additional data transfer means, a cellular communication module (e.g., GSM) and a GPS module for communicating engine faults and/or for providing the location of the vehicle to a remote subscriber.

7. An engine guard system according to claim 5, in which the additional data transfer means is a USB connection, a wireless connection (e.g., Bluetooth) or combination thereof.

8. An engine guard system according to claim 1, further comprising a “green” module for checking whether the engine comes up to an optimal temperature within a given time period.
